(19) United States
(12) Patent Application Publication
(10) Pub. No.: US 2019/0321730 A1
(43) Pub. Date: Oct. 24, 2019

(54) COGNITIVE PERSONALIZED GAME EXPERIENCE BASED ON PLAYER PERSONALITY

(71) Applicant: International Business Machines Corporation, Armonk, NY (US)

(72) Inventors: Rohit Shetty, Cary, NC (US); Logeswaran T. Rajamanickam, Tirupur (IN); Ashrith Shetty, Belthangady (IN); Arun Ramakrishnan, Chennai (IN)

(21) Appl. No.: 15/958,419

(22) Filed: Apr. 20, 2018

(51) Int. Cl. A63F 13/67; A63F 13/79; G06F 17/30; G06F 17/27; G06Q 50/00

(52) U.S. Cl. CPC A63F 13/67; A63F 13/79; G06Q 50/01; G06F 17/2785; G06F 17/30864

(57) ABSTRACT

The system, method, and computer program product described herein leverage a user's social media data to personalize the user's gameplay experience based on the user's personality traits including comparing the personality characteristics data of the user to a plurality of rules each including an expression and at least one parameter that is associated with the expression, generating a player profile for the user based on the comparison of the personality characteristics data to the plurality of rules where a value of at least one parameter in the player profile is determined based on a value of the at least one parameter of a respective rule of the plurality of rules if the expression of that respective rule is met by the personality characteristics data, personalizing a game for the user based on the parameters in the generated player profile and presenting the personalized game to the user.

### BACKGROUND

The present disclosure relates to personalizing a game experience based on a user's personality.

The technology in the gaming industry has grown rapidly over the last few years in an effort to provide a more personalized and immersive experience for the user, e.g., the player.

Currently available techniques to customize an experience are often based on the user's in game behavior and decisions and other statically available details. These customized experiences, however, do not cater to the user's truly personal and intuitive personality characteristics.

As an example, many games provide a user with various in-game options to customize their game play, for example, by increasing the game play difficulty, or adjusting various other game play settings. Some users may find certain options disagreeable. For example, this could be in the case of violent options such as those that involve game character behavior that a user might find immoral. These games and game options do not typically have a way to know what a particular user will like or dislike, nor do they know or understand an individual user's personality. This may render the user's to experience unenjoyable. In some cases, the user may not purchase the game at all.

Current game design is often limited to pre-determined decision trees, scripted events, or other similar game play schemes that are developed to target a particular group or type of user. Unfortunately, this cookie cutter approach often does not provide a truly fulfilling game play experience for the user that is configured to match his/her particular personality, needs, and wants.

### BRIEF SUMMARY

The system, method, and computer program product described herein leverage a user's social media data to personalize the user's gameplay experience based on the user's personality traits.

In an aspect of the present disclosure, a computer-implemented method is disclosed including receiving personality characteristics data associated with a user and comparing the personality characteristics data to a plurality of rules. Each rule includes an expression and at least one parameter that is associated with the expression. The method further includes generating a player profile for the user based on the comparison of the personality characteristics data to the plurality of rules. A value of at least one parameter in the player profile is determined based on a value of the at least one parameter of a respective rule of the plurality of rules if the expression of that respective rule is met by the personality characteristics data. The method further includes personalizing a game for the user based on the parameters in the generated player profile and presenting the personalized game to the user.

In aspects of the present disclosure, apparatus, systems, and computer program products in accordance with the above aspect may also be provided. Any of the above aspects may be combined without departing from the scope of the present disclosure.

### BRIEF DESCRIPTION OF THE DRAWINGS

The details of the present disclosure, both as to its structure and operation, can be understood by referring to the accompanying drawings, in which like reference numbers and designations refer to like elements.

FIG. 1 is a diagram illustrating personality traits of a user in accordance with some aspects of the present disclosure.

FIG. 2 is an illustration of personality characteristics data that may be generated based on a user's social media data in accordance with some aspects of the present disclosure.

FIG. 3 is a system diagram illustrating a system for personalizing a user's game experience based on personality traits in accordance with some aspects of the present disclosure.

FIG. 4 is a diagram illustrating a system for personalizing a user's game experience based on personality traits in accordance with some aspects of the present disclosure.

FIG. 5 is a flow chart of a method for generating a personality characteristics model in accordance with some aspects of the present disclosure.

FIG. 6 is an illustration of example rules that may be used to generate a player profile in accordance with some aspects of the present disclosure.

FIG. 7 is a flow chart of a method for generating a player profile in accordance with some aspects of the present disclosure.

FIG. 8 is an illustration of an example player profile that may be used to personalize a game for a user in accordance with some aspects of the present disclosure.

FIG. 9 is a flow chart of a method for personalizing the game based on the player profile in accordance with some aspects of the present disclosure.

FIG. 9A is a flow chart of a method for generating or modifying a behavioral tree in accordance with some aspects of the present disclosure.

FIG. 9B is a flow chart of a method for generating or modifying a difficulty function in accordance with some aspects of the present disclosure.

FIG. 9C is a flow chart of a method for generating or modifying attributes used by middleware in accordance with some aspects of the present disclosure.

FIG. 10 is an illustration of example a game that has not been personalized in accordance with some aspects of the present disclosure.

FIG. 11 is an illustration of example of the game of FIG. 10 including personalization for user B based on user B's personality traits in accordance with some aspects of the present disclosure.

FIG. 12 is an illustration of example of the game of FIG. 10 including personalization for user C based on user C's personality traits in accordance with some aspects of the present disclosure.

FIG. 13 is an exemplary block diagram of a computer system in which processes involved in the system, method, and computer program product described herein may be implemented.

### DETAILED DESCRIPTION

Personality modeling originated from the field of psychology. Multiple studies have focused on the influence of personality factors on an individuals' behavior and decisions. In particular, several researchers found that variations in word usage in writings such as blogs, essays, and tweets can predict aspects of personality.

A user's personality may be classified in a variety of different ways. For example, a user's agreeableness, conscientiousness, extraversion, emotional range and openness are often referred to as the “Big Five personality traits”. Agreeableness is a person's tendency to be compassionate and cooperative toward others. Conscientiousness is a person's tendency to act in an organized or thoughtful way. Extraversion is a person's tendency to seek stimulation in the company of others. Emotional Range, also referred to as Neuroticism or Natural Reactions, is the extent to which a person's emotions are sensitive to the person's environment. Openness is the extent to which a person is open to experiencing a variety of activities.

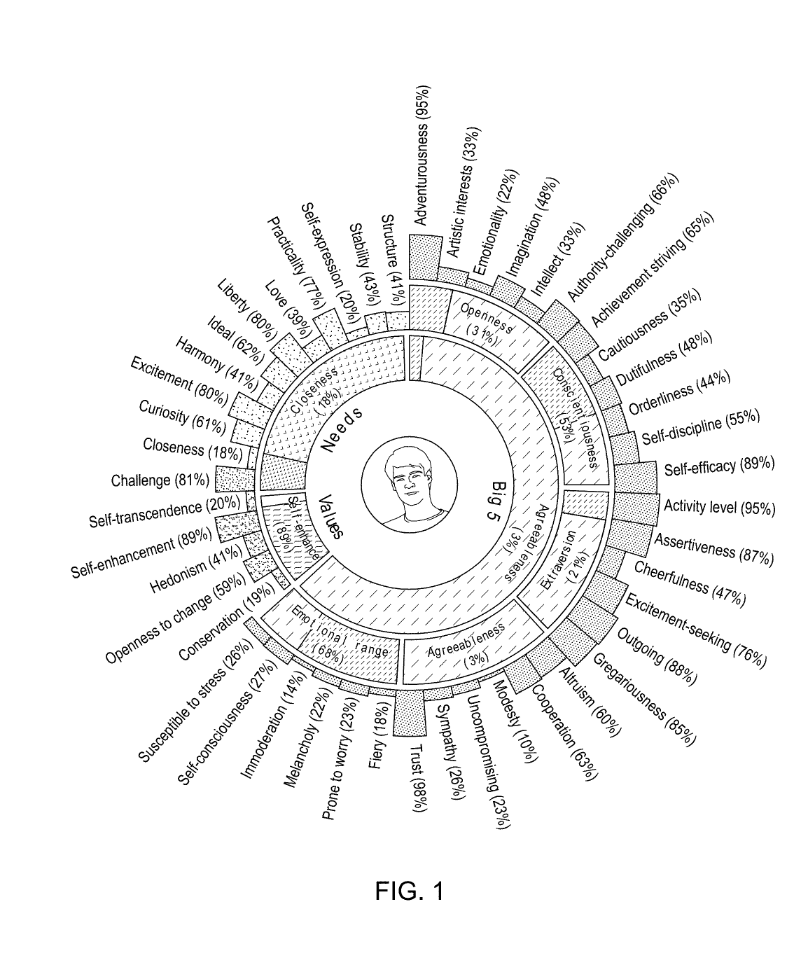

With reference now to FIG. 1, an illustration of various traits that may make up a user's personality are illustrated. These traits may be determined, for example, from the user's social media or other social interactions using a personality and sentiment analyzer (hereinafter “sentiment analyzer”).

One example of a sentiment analyzer that may be used to determine a user's traits includes the IBM Watson® Personality Insights® service, a tool produced by International Business Machines Corporation (IBM®).

The IBM Watson® Personality Insights® service, for example, provides an Application Programming Interface (API) that enables applications to derive insights regarding the personalities and traits of authors of social media or other textual matter. The service uses linguistic analytics to infer personality and social characteristics, including the Big Five personality traits, and shows Needs, and Values, from text. The output of the IBM Watson® Personality Insight Service includes the three types of personality models: Big5 (Big Five), Basic Needs and Values, illustrated in FIG. 1, each of which has various traits.

As mentioned above, the Big 5 Personality traits may include emotional range, agreeableness, extraversion, conscientiousness, and openness. As illustrated in FIG. 1, for example, the sentiment analyzer may analyze the user's social media or other textual matter to determine scores for each personality trait. For example, the sentiment analyzer may determine a score of 68% for emotional range, 3% for agreeableness, 21% for extraversion, 53% for conscientiousness, and 31% for openness. While illustrated as a percentage, any other metric for measuring scores of personality traits may be used.

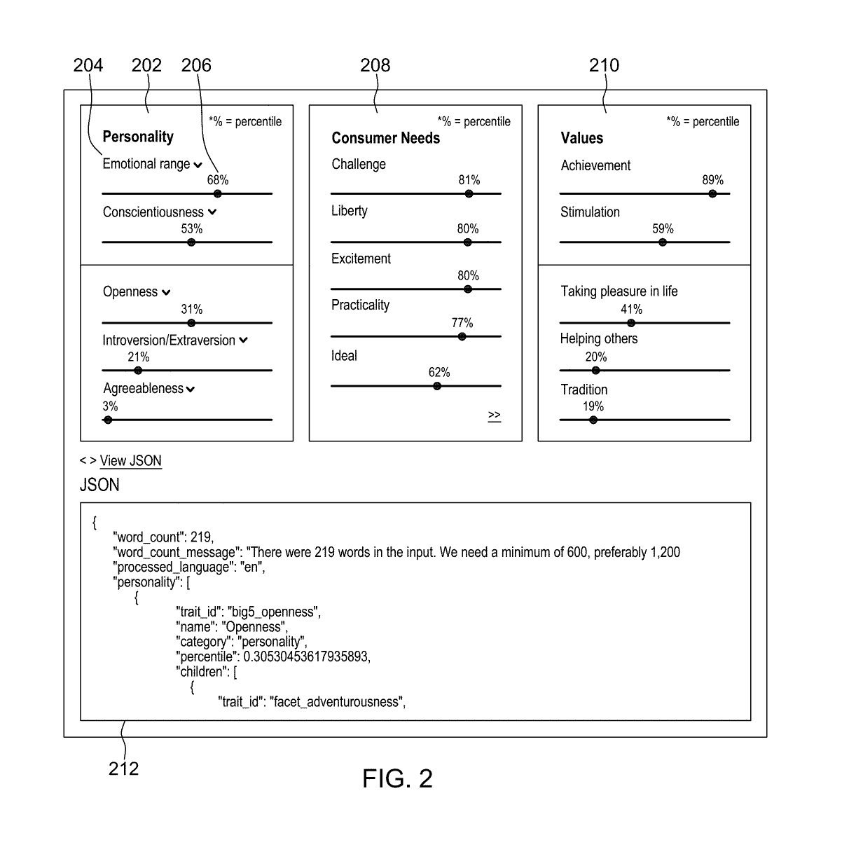

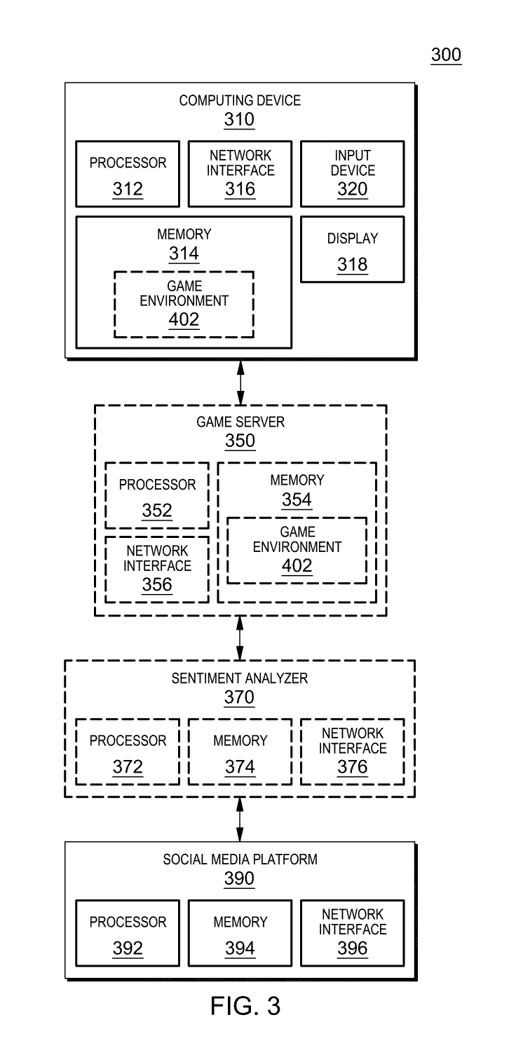

With reference now to FIG. 2, an example output of a sentiment analyzer is illustrated. For example, one or more of the personality traits in each category may be illustrated with a corresponding value, e.g., output to a display 318 (FIG. 3) as part of a graphical user interface (GUI). For example, a personality category 202 may include an emotional range personality trait 204 with a value 206 of 68%. While illustrated as a percentage, any other value format may be used. Additional personality trait categories may include, for example, consumer needs 208, values 210, or any other category of personality traits that may be analyzed by the sentiment analyzer.

In some aspects, for example, the output of the sentiment analyzer may be in the form of a text or data file. For example, the output may be captured in a JavaScript Object Notation (JSON) file 212.

With reference now to FIG. 3, a system 300 for personalizing a game experience based on a user's personality is illustrated. In some aspects, system 300 includes a computing device 310 and a social media platform 390. In some aspects, system 300 may also include one or both of a game server 350 and a sentiment analyzer 370.

Computing device 310 includes at least one processor 312, memory 314, at least one network interface 316, a display 318, an input device 320, and may include any other features commonly found in a computing device. In some aspects, computing device 310 may, for example, be a computing device associated with a user. In some aspects, for example, computing device 310 may be configured to present a game to a user, e.g., via display 318, and to receive user interactions with the game, e.g., via input device 320. In some aspects, computing device 310 may include, for example, a personal computer, laptop, tablet, smart device, smart phone, smart watch, or any other similar computing device that may be used by a user.

Processor 312 may include, for example, a microcontroller, Field Programmable Gate Array (FPGAs), or any other processor that is configured to perform various operations. Processor 312 may be configured to execute instructions as described below. These instructions may be stored, for example, in memory 314. As used herein, the term “processor” may include a single core processor, a multi-core processor, multiple processors located in a single device, or multiple processors in wired or wireless communication with each other and distributed over a network of devices, the Internet, or the cloud. Accordingly, as used herein, functions, features or instructions performed or configured to be performed by a “processor”, may include the performance of the functions, features or instructions by a single core processor, may include performance of the functions, features or instructions collectively or collaboratively by multiple cores of a multi-core processor, or may include performance of the functions, features or instructions collectively or collaboratively by multiple processors, where each processor or core is not required to perform every function, feature or instruction individually.

Memory 314 may include, for example, computer readable media or computer readable storage media in the form of volatile memory, such as random access memory (RAM) and/or cache memory or others. Memory 314 may include, for example, other removable/non-removable, volatile/non-volatile storage media. By way of non-limiting examples only, memory 314 may include a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Network interface 316 is configured to transmit and receive data or information to and from game server 350, sentiment analyzer 370, social media platform 390 or any other computing device via wired or wireless connections. For example, network interface 316 may utilize wireless technologies and communication protocols such as Bluetooth®, WWI (e.g., 802.11a/b/g/n), cellular networks (e.g., CDMA, GSM, M2M, and 3G/4G/4G LTE), near-field communications systems, satellite communications, via a local area network (LAN), via a wide area network (WAN), or any other form of communication that allows computing device 310 to transmit or receive information to or from game server 350, sentiment analyzer 370, social media platform 390.

Display 318 may include any display device that is configured to display information to a user of computing device 310. For example, in some aspects, display 318 may include a computer monitor, television, smart television, or other similar displays. In some aspects, display 318 may be integrated into or associated with computing device 310, for example, as a display of a laptop, smart phone, smart watch, or other smart wearable devices, as a virtual reality headset associated with computing device 310, or any other mechanism for displaying information to a user. In some aspects, display 318 may include, for example, a liquid crystal display (LCD), an e-paper/e-ink display, an organic LED (OLED) display, or other similar display technologies. In some aspects, display 318 may be touch-sensitive and may also function as an input device 320.

Input device 320 may include, for example, a keyboard, a mouse, a touch-sensitive display 318, a keypad, a microphone, or other similar input devices or any other input devices that may be used alone or together to provide a user with the capability to interact with computing device 310.

Game server 350 includes a processor 352, memory 354, and a network interface 356 that may include similar functionality as processor 312, memory 314, and network interface 316. In some aspects, game server 350 may, for example, be any computing device, server, or similar system that is configured to interact with, receive from, or provide data to computing device 310, sentiment analyzer 370, and social media platform 390. In some aspects, a separate game server 350 may not be included. Instead, the functionality of game server 350 described below may be executed directly by computing device 310.

Sentiment analyzer 370 includes a processor 372, memory 374, and a network interface 376 that may include similar functionality as processor 312, memory 314, and network interface 316. In some aspects, sentiment analyzer 370 may, for example, be any computing device, server, or similar system that is configured to interact with, receive from, or provide data to computing device 310, sentiment analyzer 370, and social media platform 390. Sentiment analyzer 370 is configured to determine a user's traits and generate respective scores for the traits, for example, based on social media data received from social media platform 390. As mentioned above, an example sentiment analyzer 370 that may be used to determine a user's traits includes IBM Watson® Personality Insights® service. In some aspects, a separate sentiment analyzer 370 may not be included. Instead, the functionality of sentiment analyzer 370 may be executed directly by computing device 310, game server 350, or a combination of computing device 310 and game server 350.

Social media platform 390 includes a processor 392, memory 394, and a network interface 396 that may include similar functionality as processor 312, memory 314, and network interface 316. In some aspects, social media platform 390 may, for example, be any computing device, server, or similar system that is configured to interact with or provide data to computing device 310, game server 350, and sentiment analyzer 370. In some aspects, for example, social media platform 390 may include social media web sites or applications, back end processing, or other similar devices associated with one or more social media providers, e.g., Facebook®, Twitter®, Instagram®, or any other social media provider. In some aspects, social media platform 390 may be any data repository storing data about users of social media or activities of users on the internet.

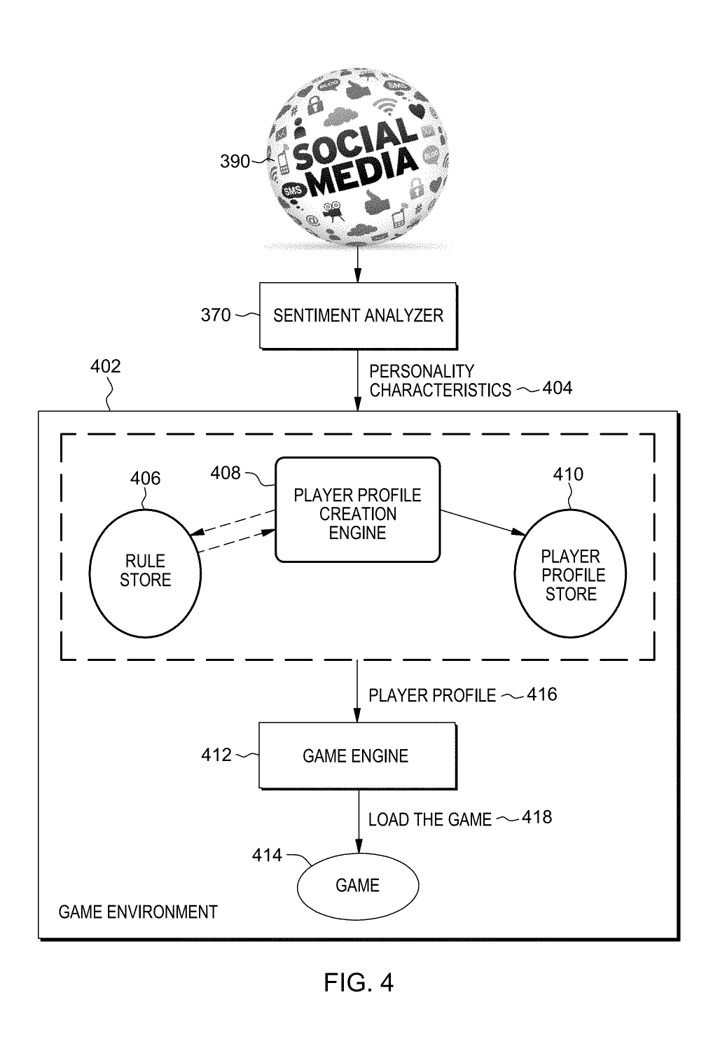

With reference now to FIG. 4, a game environment 402 that is executed to implement a video game may receive personality characteristics data 404 from sentiment analyzer 370. For example, the received personality characteristics data 404 may be in the form of a JSON file. The sentiment analyzer 370 may generate the personality characteristics data 404 as described above based on data received from social media platform 390.

Game environment 402, for example, may be instructions or software loaded or resident in memory 314 of computing device 310, memory 354 of game server 350, or both. For example, in some aspects, the entire game environment 402 may be stored in memory 314, e.g., when no game server is present. In some aspects, a portion of game environment 402 may be stored in each of game server 350 and computing device 310. For example, in the case of a multiplayer game, game server 350 may store information such as user profile data, gameplay data, in-game location based data, or any other data corresponding to multiple users of the game server 350 or functions of the game server 350, while computing device 110 may store graphics data, user input data, user profile data or other data corresponding to the specific user or the function of the specific user's computing device.

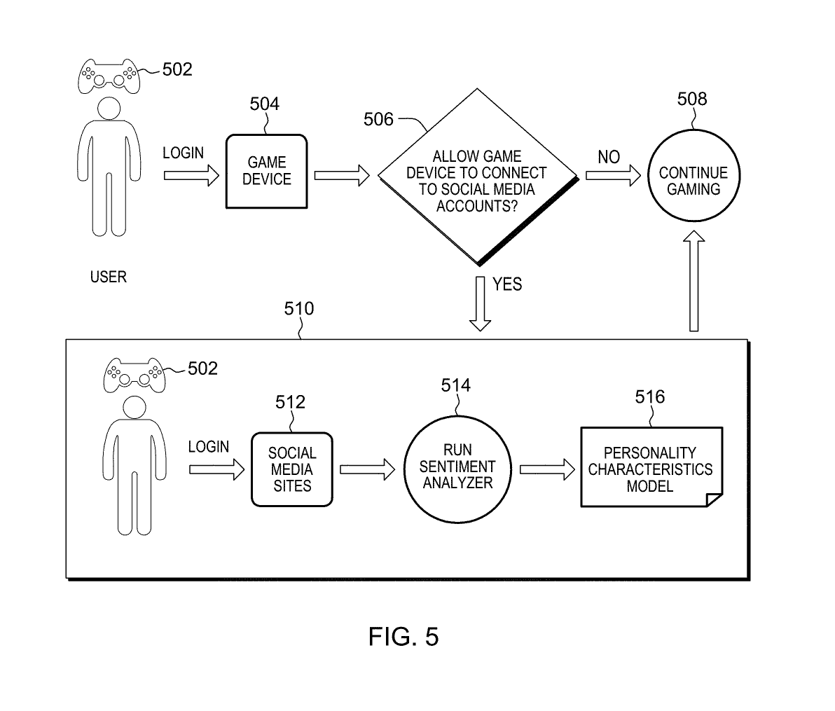

With reference now to FIG. 5, for example, a user 502 may login to a game device, e.g., computing device 310, at 504. At 506, the user 502 may be prompted, e.g., via display 318, with the option to allow the game device to connect to the user's social media accounts. In some aspects, for example, the prompt may be presented to the user 502 each time the user logs into the game device. In some aspects, the user may allow the game device to automatically connect to the user's social media accounts in for all future logins. In some aspects, the user 502 may be prompted only when creating a user profile.

If the user 502 decides not to allow the game device to connect to the user's social media accounts, e.g., via input device 320, the user 502 may continue gaming on the game device 504 under standard settings that are not personalized to the user's personality at 508.

If the user 502 decides to allow the game device 504 to connect to the user's social media accounts, e.g., by providing credentials or other authorization via input device 320, a data mining and sentiment analysis process 510 may be performed.

In the data mining and sentiment analysis process 510, the user 502 provides login credentials or otherwise logs into social media sites at 512, e.g., social media platforms 390.

The user's social media data may then be mined from the social media sites and analyzed by running sentiment analyzer 370 at 514 and a person characteristics model including personality characteristics data 404 may be generated by the sentiment analyzer 370 as described above.

With reference again to FIG. 4, the generated personality characteristics data 404 may be received by the game environment 402 from sentiment analyzer 370 for use in generating the player profile.

With reference again to FIG. 4, game environment 402 includes a rule store 406, player profile creation engine 408, player profile store 410, a game engine 412, and a game 414.

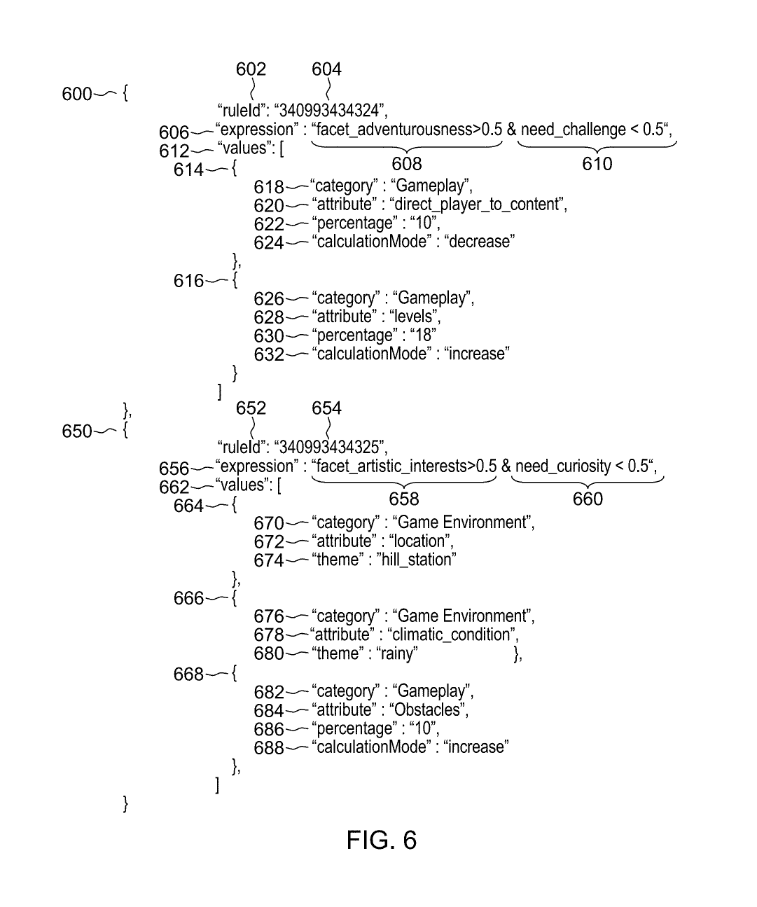

Rule store 406 may, for example, be a database storing rules for creating a player profile based on personality characteristics data 404 received from sentiment analyzer 370. With reference now to FIG. 6, example rules that may be stored in rules store 406 are illustrated as rules 600 and 650.

Using rule 600 as an example, each rule includes a rule identifier 602 that uniquely identifies the rule. In this example, the ruleID 602 includes a value 604 of “340993434324”.

Each rule also includes an expression that may be applied to the personality characteristics data 404 to determine whether to execute the rule. For example, rule 600 includes an expression 606 having one or more components, e.g., components 608 and 610, that define the rule 600. In expression 606, component 608 includes a comparison of a parameter, e.g., facet_adventurousness, to a threshold value, e.g., 0.5, using an operator, e.g., >. For example, component 608 may be met if the facet_adventurousness parameter is greater than 0.5. While component 608 is provided as an example, any other parameter that may be found in the personality characteristics data 404 may be used for comparison. In addition, any threshold value and operator may be used or set for determining whether the component is satisfied. For example, if a developer determines that certain personality characteristics map to particular gameplay personalizations, the developer may set the parameters, threshold values, and operators accordingly to trigger the gameplay personalization when such personality characteristics are found in the personality characteristics data 404.

In some aspects, the expression for a rule may have more than one component. For example, rule 600 includes an expression 606 that includes components 608 and 610. In rule 600, component 610 may be met if the parameter need_challenge is less than 0.5.

In some aspects, the expression of a rule may be met only if all of the components are satisfied. For example, expression 606 includes the symbol “&” which may indicate that both components 608 and 610 must be met to effect a change to the user's profile and thus a personalization of the user's game experience. In some aspects, a particular rule expression may only require one of the components to be met. In some aspects, a particular rule expression may require any combination of the components need to be met.

Each rule also includes one or more values 612, e.g., value 614 and value 616, including parameters that may be updated when the expression is met. For example, value 614 may include parameters that define the value including, e.g., a category parameter, attribute parameter, percentage parameter, and calculation mode parameter. In some aspects, these parameters may be denoted as value.category, value.attribute, value.percentage, and value.calculationmode. Other or different parameters may be included in each value. For example, as seen in FIG. 6, value 664 may include a theme parameter 674 that sets a theme for the game environment.

The category parameter for a particular value denotes the category in the player profile that will get updated if the expression is met. As an example, the category parameter 618 for value 614 may include a category of “Gameplay” which denotes that value 614 is for updating the gameplay category in the player profile.

The attribute parameter for a particular value denotes the attribute within the specified category that will get updated if the expression is met. As an example, the attribute parameter 620 for value 614 may include an attribute of “direct_player_to_content” which denotes that value 614 updates the attribute in the player profile that relates to whether the player should be directed to additional content.

The percentage parameter for a particular value denotes the percentage that the specified attribute will get updated if the expression is met. As an example, the percentage parameter 622 included in value 614 may include a value of “10” which denotes that the attribute, e.g., “direct_player_to_content”, will be updated by 10% in the player profile.

The calculation mode parameter for a particular value denotes whether to increase or decrease the attribute by the specified percentage if the expression is met. For example, the calculation mode parameter 624 included in value 614 is “decrease” which denotes that the attribute “direct_player_to_content” will be decreased by 10%, i.e., the value of the percentage parameter 622.

As further illustrated in FIG. 6, for example, value 616 may include a category parameter 626 of “gameplay”, attribute parameter 628 of “levels”, percentage parameter 630 of “18” and calculation mode parameter 632 of “increase” which denotes that the levels attribute of the gameplay category will be increased by 18 percent, e.g., the number of levels for the user to achieve in the game may be increased by 18%.

As further illustrated in FIG. 6, for example, value 616 may include a category parameter 626 of “gameplay”, attribute parameter 628 of “levels”, percentage parameter 630 of “18” and calculation mode parameter 632 of “increase” which denotes that the levels attribute of the gameplay category will be increased by 18 percent, e.g., the number of levels for the user to achieve in the game may be increased by 18%.

With continued reference to FIG. 6, rule 650 may include a rule ID 652 having a value 654 of “34099343434325” and an expression 656 including components 658 and 660. Component 658 may include a determination of whether the personality trait “facet_artistic_interest” is greater than a threshold value of 0.5 and component 660 may include a determination of whether the personality trait “need_curiosity” is less than a threshold value of 0.5. In the case of expression 656, if both of these components are met, the values 662 included in rule 650, i.e., values 664, 666, and 668 may be updated.

For example, value 664 may include a category parameter 670 of “Game Environment”, attribute parameter 672 of “location”, and a theme parameter 674 of “hill_station” which denotes that the location attribute in the game environment category of the user profile will be updated to include the hill station theme.

As another example, value 666 may include a category parameter 676 of “Game Environment”, attribute parameter 678 of “climatic_condition”, and a theme parameter 680 of “rainy” which denotes that the climatic condition attribute in the game environment category of the user profile will be updated to include the rainy theme.

As another example, value 668 may include a category parameter 682 of “Gameplay”, attribute parameter 684 of “Obstacles”, a percentage parameter 686 having a value of “10”, and a calculation mode parameter 688 of “increase” which denotes that the Obstacles attribute in the gameplay category of the user profile will be updated to increase the number of obstacles by 10%.

With reference again to FIG. 4, player profile creation engine 408 is configured to receive personality characteristics data 404 from sentiment analyzer 370 and apply the rules from rule store 406 to update and personalize the user's player profile. For example, as described above, the user's personality characteristics data 404, e.g., the scores for each personality trait, may be compared to the expressions found in the rules to determine what attributes of the user's player profile need to be updated or generated and how they need to be updated or generated. Once the user's personality characteristics data 404 has been used to update or generate the user's player profile based on the rules stored in rule store 406, the user's player profile may be stored in the player profile store 410.

In some aspects, for example, player profile creation engine 408 may include instructions stored in memory 314 of computing device 110, memory 354 of game server 350, or both, for example, as part of game environment 402. The instructions may be configured to cause the respective processor 312, 352 to compare the rules stored in rule store 406 to the received personality characteristics data 404 to determine whether any expressions of the rules are met and update or generate the user's player profile accordingly.

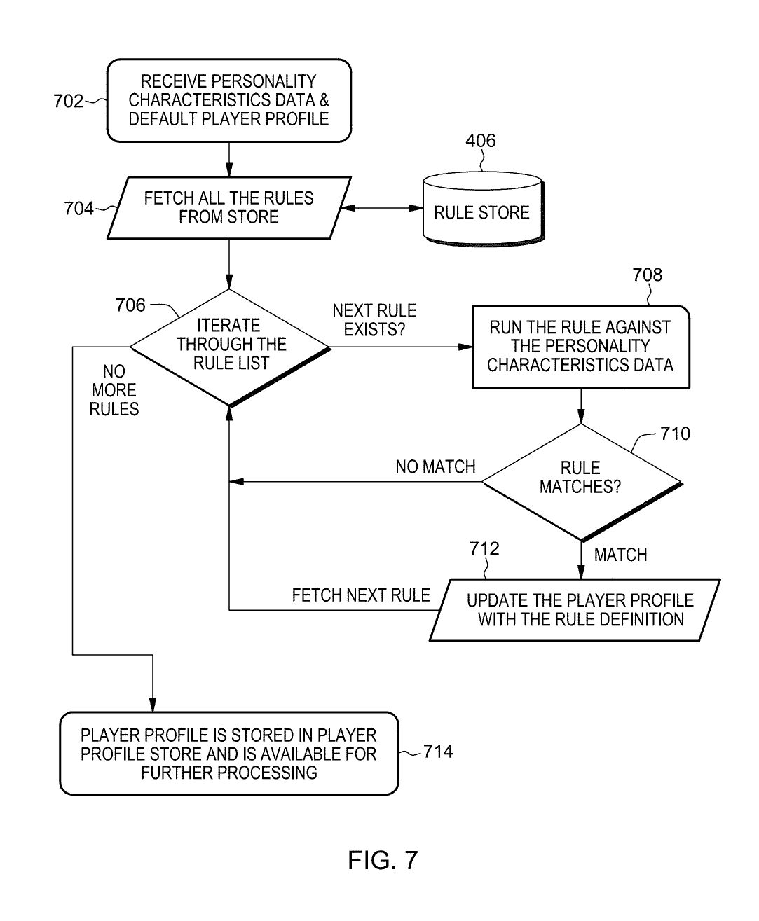

With reference now to FIG. 7, a method for generating a player profile for a user using player profile creation engine 408 is illustrated.

At 702, player profile creation engine 408 receives the personality characteristics data 404 from sentiment analyzer 370 and a default player profile to be used as a basis for generating a personalized player profile for the user. For example, player profile creation engine 408 may receive a JSON file including each of the player's personality traits paired with a score or value, e.g., a percentage. The default player profile may include a set of pre-determined values or other data that correspond to an average or generic user.

At 704, player profile creation engine 408 fetches the rules from rule store 406.

At 706, player profile creation engine 408 determines whether there are any rules from the rule store that have not been checked against the received personality characteristics data 404. For example, player profile creation engine 408 may iterate through the rules found in rule store 406.

If a rule exists that has not been checked, player profile creation engine 408 runs the rule against the personality characteristics data 404 at 708 to determine whether the expression for the rule is met by the user's personality characteristics, e.g., whether the scores for particular personality traits in the user's personality characteristics data 404 meets the components in the expression.

At 710, player profile creation engine 408 determines whether the expression in the rule matches the user's personality characteristics data 404, e.g., do the values for the particular traits being tested by the components of the expression for that rule meet the required comparison and threshold.

If player profile creation engine 408 determines that the rule does not match, the method returns to 706 to fetch the next rule for comparison.

If player profile creation engine 408 determines that the rule does match, the player profile is updated with the rule definition, e.g., the changes set forth in the values of the rule, at 712, and the method returns to 706 to fetch the next rule for comparison.

If at 706, player profile creation engine 408 determines that no more rules are left to be compared to the personality characteristics data 404, the player profile is stored in the player profile store at 714, and made available for further processing by game engine 412.

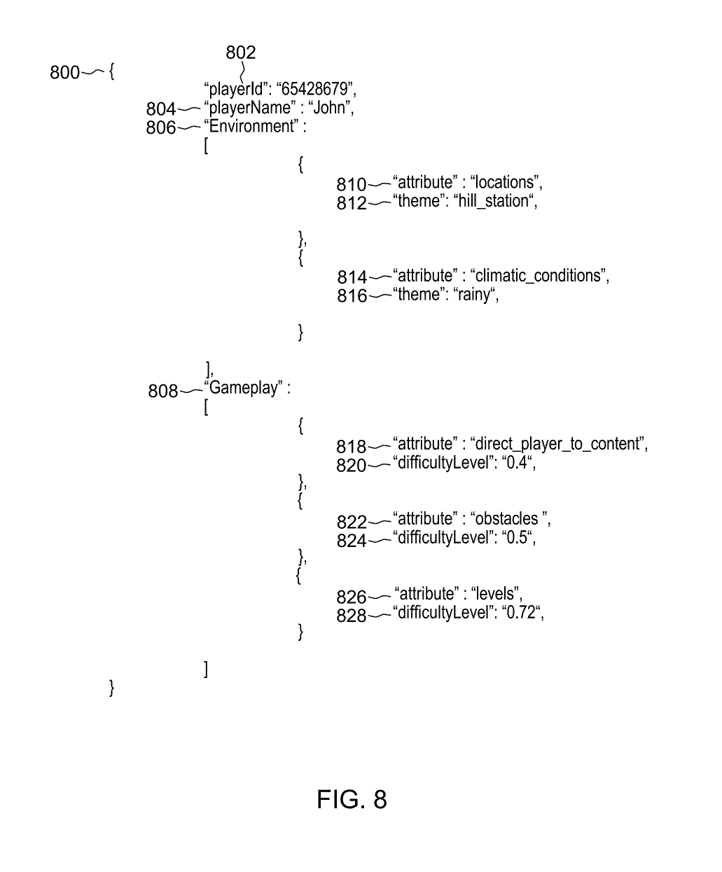

With reference now to FIG. 8, an example player profile 800 that may be generated by player profile creation engine 408 is illustrated.

Player profile 800 includes a player ID parameter 802 and player name parameter 804. For example, player ID parameter 802 may include a value that uniquely identifies the player profile. For example, the player ID parameter 802 may have a value of “65428679”.

Player name parameter 804 may include identifying information about the player or a user name for the player. For example, if the player's name or username is John, the player name parameter may include a value that is the text string “John”.

Player profile 800 further includes categories parameters that may be similar to those categories found in the rules of rules store 404. For example, player profile 800 may include a category 806 of “Environment”, and a category 808 of “Gameplay”. In some aspects, other categories may also be present.

The “Environment” category 806 may include attribute parameters 810 and 814. Attribute parameter 810 may include a value of “locations” and may be associated with a corresponding theme parameter 812 of “hill_station”. Attribute parameter 814 may include a value of “climatic_conditions” and may be associated with a corresponding theme parameter 816 of “rainy”. In some aspects, each parameter may be associated with a corresponding parameter of some type that may be adjusted by a match between the rules and the personality characteristics data 404. For example, if the user's personality characteristics data 404 is determined to match a rule that sets the “climactic conditions” attribute to the theme “sunny”, this may result in an update to the “Environment” category of the player profile. For example, the theme parameter 816 of “rainy” may be replaced with “sunny”. As another example, a new theme parameter of “sunny” may be associated with the “climatic_conditions” attribute parameter 816 in addition to the theme parameter of “rainy”. As another example, an additional “climatic_conditions” attribute parameter having a corresponding theme parameter of “sunny” may be added to the “Environment” category 806. These examples are non-limiting and other ways of adding the “sunny” theme to the “Environment” category 806 may be implemented.

The “Gameplay” category 808 may include attribute parameters 818, 822, and 826. Attribute parameter 818 may include a value of “direct_player_to_content” and may be associated with a corresponding difficulty level parameter 820 having a value of “0.4”. Attribute parameter 822 may include a value of “obstacles” and may be associated with a corresponding difficulty level parameter 824 of “0.5”. Attribute parameter 826 may include a value of “levels” and may be associated with a corresponding difficulty level parameter 828 of “0.72”. When a rule specifies that the attribute “direct_player_to_content” is decreased by 10%, for example, the corresponding difficulty level parameter 820 may be reduced from a value of “0.4” to “0.36”. In some aspects, for example, where the difficulty level parameter 820 represents a percentage, e.g., the value of “0.4” denotes 40%, the reduction by 10% may alternatively involve reducing the value from “0.4” to “0.3”.

With reference again to FIG. 4, the game engine 412 may receive a user's player profile 416, e.g., from player profile store 410, and may generate a personalized game for the user based on the user's player profile 416. For example, the game engine may generate the game based on the parameters for each category in the user's player profile 416. In some aspects, for example, the game engine may generate the game based on the environment and gameplay categories.

The environment category may include parameters related to, for example, playing characters, locations, climatic conditions, items, puzzles, missions involved in the game, animations, user interface, conceptual elements, transitions between levels, and other similar environmental, user interface, or similar environmental settings that affect how the player sees the game.

The gameplay category may include parameters related to the creation of a back-story, setting and theme for the game, screenplay of the story, number of levels involved in the game, how the Game's Hook will be demonstrated, how players are directed to content or explore the game's theme or story, management of tension and intensity, draw attention references and research, objectives, obstacles, hidden features, wiring of levels, or other similar gameplay settings that affect how the player plays the game.

While environment and gameplay categories are described above, any number of other categories that may affect the generation of a game may also be used.

The game engine 412 may load the game using multiple components, e.g., behavioral trees, level builders, animation builders, etc., that are adjusted based on the parameters found in the player profile.

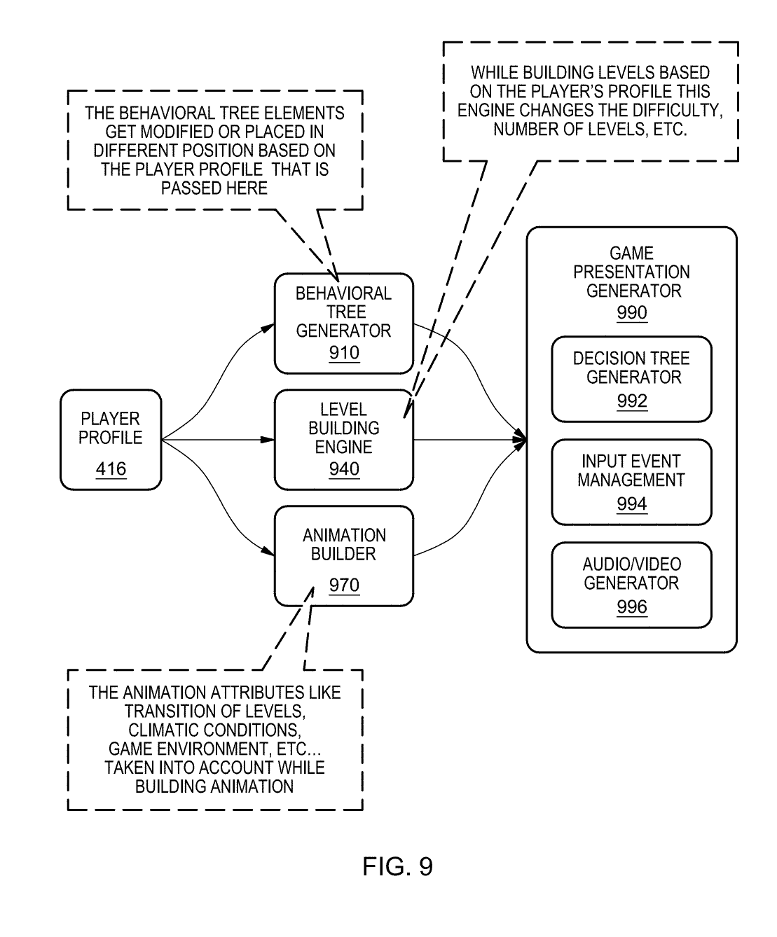

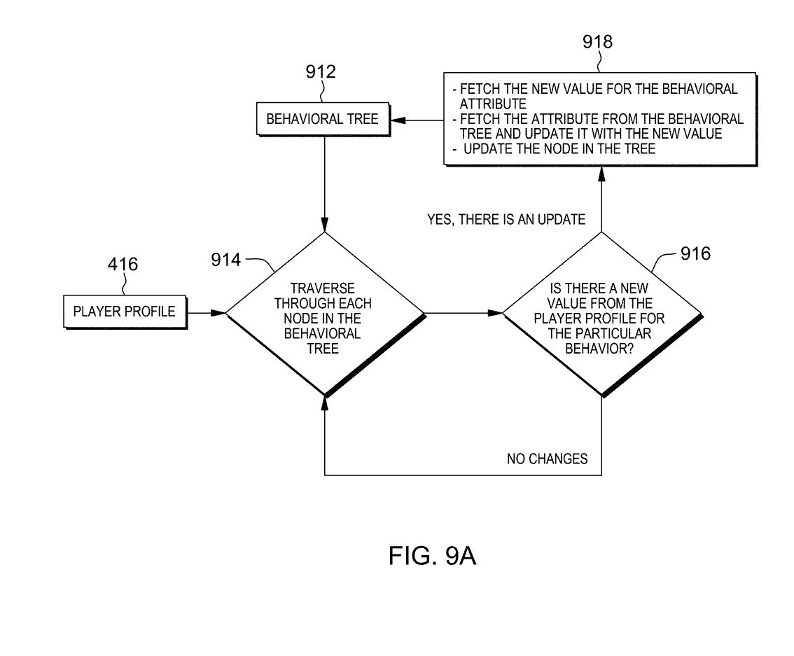

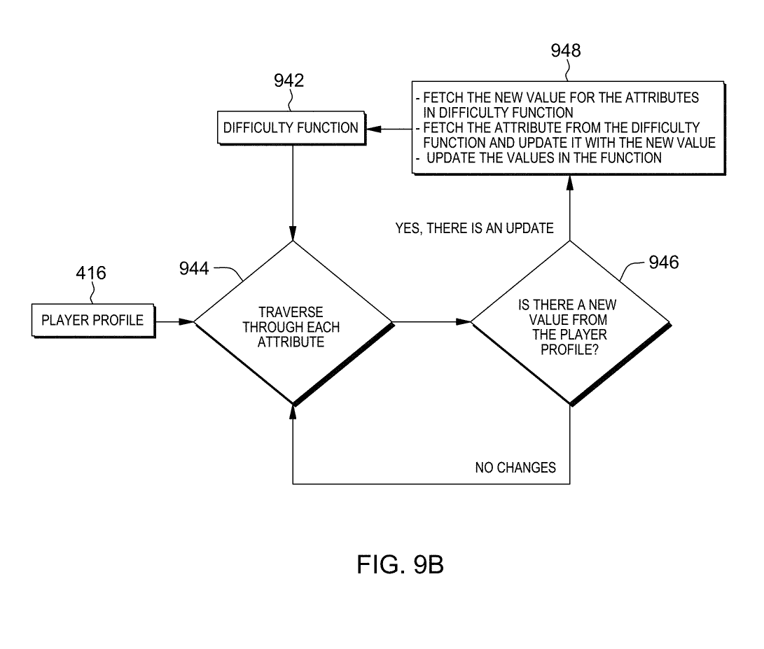

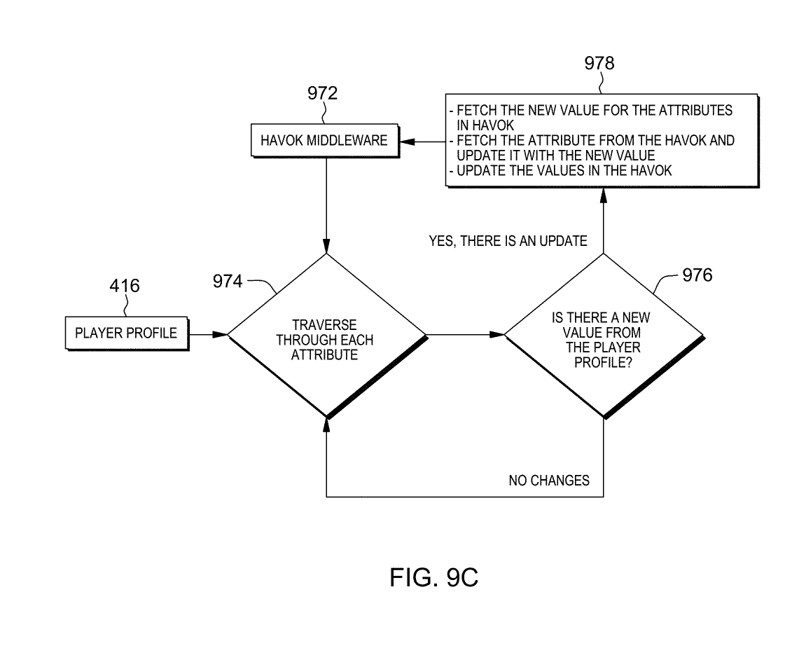

With reference now to FIG. 9, for example, the player profile 416 received by game engine 412 may be fed into a behavioral tree generator 910, level building engine 940, and animation builder 970.

With reference now to FIGS. 9 and 9A, behavioral tree generator 910 generates a behavioral tree for the user's in-game experience, e.g., a decision tree controlling how the game will behave. Based on the parameters found in the user's player profile, tree elements may be modified or even relocated to different positions within the tree.

In the below example, if the facet_adventurousness and need_challenge behavior is different for a player than the player's current behavioral tree, then that attribute is modified and updated in the node of the player's behavior tree.

“ruleId”: “340993434324”,
“expression” : “facet_adventurousness>0.5 & need_challenge < 0.5“,
“values”:
[

{
“category” : “Gameplay”,
“attribute” : “direct_player_to_content”,
“percentage” : “10”,
“calculationMode” : “decrease”
}

]

As seen in FIG. 9A, for example, a method of generating or updating the behavioral tree 912 for a player based on the player profile 416 using behavioral tree generator 910 is illustrated.

At 914, each node of the current behavioral tree 912 for the player is traversed and compared to the player's player profile 416. In some aspects, for example, where the player does not yet have a customized behavioral tree 912, a template or standard behavioral tree may be used as a basis for generating the player's behavioral tree. At 916, behavioral tree generator 910 determines whether there is a new or changed value from the player profile 416 for a particular behavior node being traversed. If the behavioral tree generator 910 determines that no change is present, the method returns to 914 and analyzes the next node. If the behavioral tree generator 910 determines that there is an updated value, the new value for the behavioral attribute is fetched and the behavioral tree is updated with the new value at 918. Behavioral tree generator 910 then continues to traverse the nodes of the behavioral tree at 914 if any nodes are left to be traversed.

With reference now to FIGS. 9 and 9B, level building engine 940 builds the game levels and may change the difficulty, number of levels, etc. based on the parameters in the player profile.

The difficulty evaluation function may be based on a number of properties that must fulfill the difficulty of a challenge a, D(a). For example, in some aspects, D may be measurable using a tool that is able to record the internal states of the game. As another example, D may allow for a comparison of the difficulty of two challenges, especially when the challenges are of the same “kind”, e.g., jumping in a platform game. As another example, D may be relative to the game history. For example, D may be relative to the progression of the player's skill according to the set of challenge already overcome. As another example, D may depend on the time used to finish the challenge.

Let A be the set of all challenges that have been solved before time 0. There is a LOSE(a, t) and WIN(a, t) as the following events:

LOSE(a, t)=the automaton of a reaches the state LOSE before time t, starting at time 0.

WIN(a, t)=the automaton of a reaches the state WIN before time t, starting at time 0.

The difficulty D may be defined as a conditional probability according to equation (1) below:

D(a,t)=Probability{LOSE(a,t)/A} (1)

The Easiness E of a may be defined in the same way according to equation (2) below:

E(a,t)=Probability{WIN(a,t)/A} (2)

At all time D(a, t)+E(a, t)≤1.

We can also consider the steady state difficulty and easiness as set forth in equations (3) and (4) below:

D*(a)=limt→∞D(a,t) (3)

E*(a)=limt→∞E(a,t) (4)

If challenge a must necessarily be finished in the game D*(a)+E*(a)=1.

These functions provide two kinds of information about the challenge difficulty. First, E* provides the difficulty of the challenge in terms of the probability that a player can overcome it.

E* may be more precisely defined with E(a, t), where the probability that a player has to overcome the challenge before time t may be determined. The game designers may implement some triggers in the game code associated to the transitions in each challenge automaton during a test performed by players. The time needed to perform a challenge and the fact that a challenge has been successful or not may be recorded.

The values that are fed into the Difficulty Evaluation Function may be the values received from the Player Profile, for example, as shown in the below pseudo code:

“ruleId”: “340993434324”,
“expression” : “facet_adventurousness>0.5 & need_challenge < 0.5“,
“values”:
[

{
“category” : “Gameplay”,
“attribute” : “levels”,
“percentage” : “18”,
“calculationMode” : “increase”
}

]

As seen in FIG. 9B, for example, a method of generating or updating the difficulty function 942 for a player based on the player profile 416 using level building engine 940 is illustrated.

At 944, each attribute of the difficulty function 942 for the player is traversed and compared to the player's player profile 416. In some aspects, for example, where the player does not yet have a customized difficulty function 942, a template or standard difficulty function may be used as a basis for generating the player's difficulty function 942. At 946, level building engine 940 determines whether there is a new or changed value from the player profile 416 for a particular attribute being traversed. If the level building engine 940 determines that no change is present, the method returns to 944 and analyzes the next attribute. If the level building engine 940 determines that there is an updated value, the new value for the attribute is fetched and the difficulty function is updated with the new value at 948. Level building engine 940 then continues to traverse the attributes of the difficulty function 942 if any attributes are left to be traversed.

Animation builder 970 generates gameplay animations based on the parameters found in the player profile including, for example, adjusting the transition of levels, climatic conditions, game environment, etc.

Animation builder 970 may be implemented by middleware that is commonly used in the gaming industry. For example, the four most widely used middleware packages that provide subsystems of functionality for an animation builder include Bink® by RAD Game Tools, FMOD™ by Firelight, middleware tools by Havok®, and Scaleform GFx by Scaleform® Corporation. RAD Game Tools develops Bink® for basic video rendering, along with Miles audio, and Granny 3D rendering. Firelight FMOD™ is a low cost robust audio library and toolset. Havok® provides a robust physics simulation system, along with a suite of animation and behavior applications. For these middleware, the attributes from Player Profile can be mapped and influence the changes accordingly.

As seen in FIG. 9C, for example, a method of generating or updating gameplay for a player using middleware 972 based on the player profile 416 using animation builder 970 is illustrated.

At 974, each attribute used by the middleware 972, e.g., Havok® middleware, for the player is traversed and compared to the player's player profile 416. At 976, animation builder 970 determines whether there is a new or changed value from the player profile 416 for a particular attribute being traversed. If the animation builder 970 determines that no change is present, the method returns to 974 and analyzes the next attribute. If the animation builder 970 determines that there is an updated value, the new value for the attribute is fetched and the attributed used by the middleware 972 is updated with the new value at 978. Animation builder 970 then continues to traverse the attributes used by the middleware 972 if any attributes are left to be traversed.

The outputs of behavioral tree generator 910, level building engine 940, and animation builder 970 are fed into a game presentation generator 990 that generates the actual game presentation. For example, game presentation generator 990 may implement a decision tree generator 992 that generates a decision tree for the game, an input event manager 994 that determines when the game will require user input events, e.g., as part of an in-game dialogue, etc., and an audio/video generator 996 that determines what audio and visual elements are presented to the user during the game.

Behavioral tree generator 910 generates the behavior tree of the current player. The tree will be generated based on how adventurous the player is in real life or whether and how much the player enjoys facing challenges. These factors are fetched from the Player Profile which is fed into the Game Engine. Once this tree is formed, the game engine uses the tree for further generation of the game.

Level building engine 940 determines what the level for the game and the difficulty level of the game based on the parameters which are fetched from the analyzer.

Animation builder 970 utilizes commonly available middleware to decide on what animation will go into the Game. When there is a request for a change in climatic conditions based on the output of Player Profile, for example, the attributes for the middleware will be updated accordingly and the player will start seeing climate that the player likes.

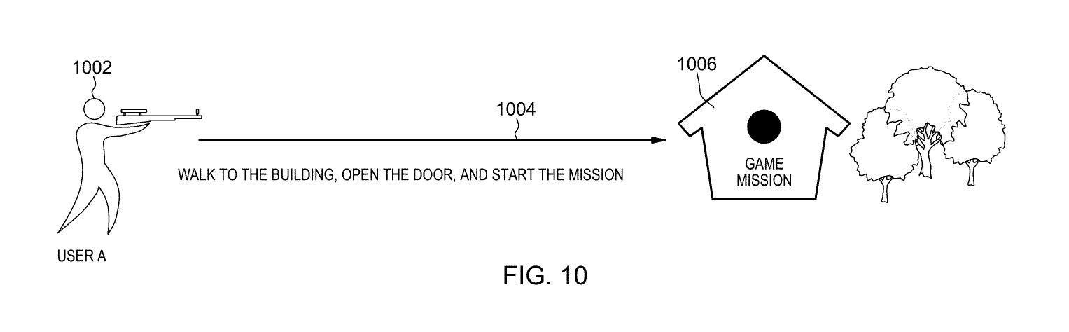

With reference now to FIG. 10, an example game without personalization is illustrated, e.g., if a user A 1002 does not allow the game device to connect to social media platform 390 at 506 (FIG. 5). The game engine 412 (FIG. 4) loads the game 414 (FIG. 4) at 418 (FIG. 4) without personalization and presents the game 414 to user A, e.g., via display 118. As can be seen, in this non-personalized game, user A, is required to perform a simple action 1004, e.g., walk to the building, open the door, and start the mission, in order to being a game mission 1006.

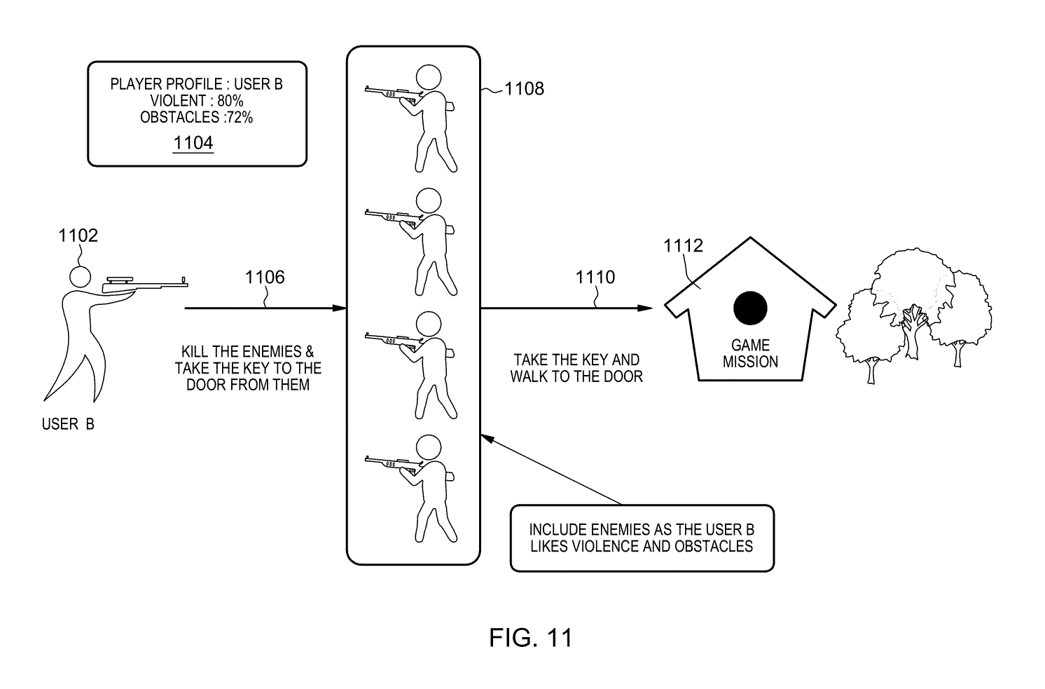

With reference now to FIG. 11, an example game with personalization is illustrated, e.g., if a user B 1102 does allow the game device to connect to social media platform 390 at 506 (FIG. 5), user B's social media data is analyzed by the sentiment analyzer 370 to generate personality characteristics data 404 for user B, the personality characteristics data 404 is received by the player profile creation engine 408 and compared to the rules stored in rule store 406 by player profile creation engine 408 to generate or adjust the player profile 416 for user B, the player profile 416 for user B is provided to the game engine 412, and the game engine generates the personalized game for user B based on the player profile 416, as described above. The game engine 412 (FIG. 4) loads the game 414 (FIG. 4) at 418 (FIG. 4) with personalization and presents the game 414 to user B, e.g., via display 118.

In this example, the player profile 1104 for a user B 1102, includes a parameter “violent” that has a value of 80%, and a parameter “obstacles” that has a value of 72%. Game engine generates the game based on these parameters to include enemies 1108 for user B to confront before proceeding to the mission since user B's player profile indicates that user B likes both violence and obstacles. User B now has to kill the enemies 1108 to obtain a key at 1106, and walk to and unlock a door at 1110 to proceed to the mission 1112. As can be seen, this game experience has been personalized based on the user's personality to provide a more enjoyable gaming experience that aligns with the user's personality traits.

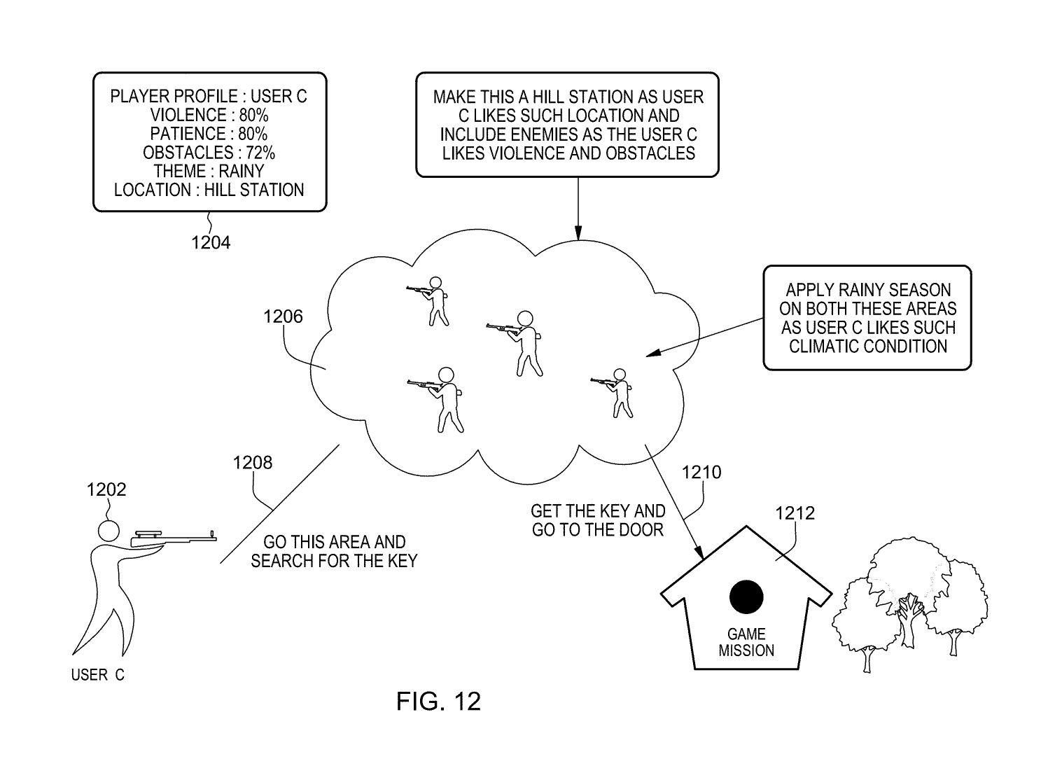

With reference now to FIG. 12, another example game with personalization is illustrated, e.g., if a user C 1202 allows the game device to connect to social media platform 390 at 506 (FIG. 5), user C's social media data is analyzed by the sentiment analyzer 370 to generate personality characteristics data 404 for user C, the personality characteristics data 404 for user C is received by the player profile creation engine 408 and compared to the rules stored in rule store 406 by player profile creation engine 408 to generate or adjust the player profile 416 for user C, the player profile 416 for user C is provided to the game engine 412 and the game engine generates the personalized game for user C based on the player profile 416, as described above. The game engine 412 (FIG. 4) loads the game 414 (FIG. 4) at 418 (FIG. 4) with personalization and presents the game 414 to user C, e.g., via display 118.

In this example, the player profile 1204 for a user C, includes a parameter “violence” that has a value of 80%, a parameter “patience” that has a value of 80%, a parameter “obstacles” that has a value of 72%, a parameter “theme” that has a value of “rainy”, and a parameter “location” that has a value of “hill station”. Game engine generates the game based on these parameters to include enemies 1206 for user C to confront before proceeding to the mission since user C's player profile indicates that user C likes both violence and obstacles. In addition, the generated game requires the user to search for the enemies 1206 in the hill station location during a rainy season at 1208 because user C's player profile indicates that user C is patient, likes the hill station location and likes the rainy theme. User C now has to travel to the hill station location and search for the key while dealing with the enemies 1206 in the rain. Once the key is found and enemies dealt with, user C may walk to and unlock a door at 1210 to proceed to the mission 1212. As can be seen, this game experience has been personalized based on the user's personality to provide a more enjoyable gaming experience that aligns with the user's personality traits.

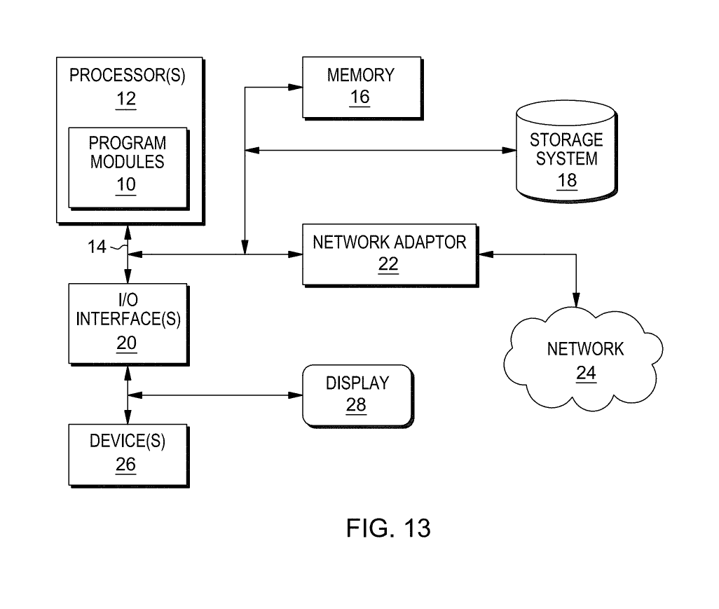

FIG. 13 illustrates a schematic of an example computer or processing system that may implement any portion of system 300, computing device 310, game server 350, sentiment analyzer 370, social media platform 390, systems, methods, and computer program products described herein in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a software module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method implemented by at least one hardware processor comprising:
receiving personality characteristics data associated with a user;
comparing the personality characteristics data to a plurality of rules, each rule comprising an expression and at least one parameter that is associated with the expression;
generating a player profile for the user based on the comparison of the personality characteristics data to the plurality of rules, a value of at least one parameter in the player profile being determined based on a value of the at least one parameter of a respective rule of the plurality of rules, if the expression of that respective rule is met by the personality characteristics data;
personalizing a game for the user based on the parameters in the generated player profile; and
presenting the personalized game to the user via a display interface of a computing device.

2. The method of claim 1, further comprising:
presenting the user with an inquiry via the display interface, the inquiry requesting access to social media data associated with the user on at least one social media platform; and
receiving an input from the computing device, the input comprising approval to access the user's social media data,
wherein the personality characteristics data is generated by a sentiment analyzer, the sentiment analyzer accessing the at least one social media platform based on the received input approving access to the user's social media data.

3. The method of claim 1, wherein the personality characteristics data comprises scores for each of a plurality of personality traits of the user.

4. The method of claim 3, wherein the at least one expression includes a comparison of one of scores to a pre-determined threshold using an operator.

5. The method of claim 1, wherein personalizing the game comprises personalizing at least one of an environment and gameplay of the game based on the parameters in the generated player profile.

6. The method of claim 1, wherein generating the player profile comprises receiving a default player profile and modifying the default player profile based on the comparison of the personality characteristics data to the plurality of rules.

7. The method of claim 1, wherein the at least one parameter of each of the plurality of rules comprises a plurality of parameters including a category parameter, an attribute parameter associated with the category parameter, and at least one other parameter associated with the attribute parameter that indicates a change to the attribute parameter if the expression for the respective rule is met.

8. A system comprising at least one processor comprising hardware, the at least one processor configured to:
receive personality characteristics data associated with a user;
compare the personality characteristics data to a plurality of rules, each rule comprising an expression and at least one parameter that is associated with the expression;
generate a player profile for the user based on the comparison of the personality characteristics data to the plurality of rules, a value of at least one parameter in the player profile being determined based on a value of the at least one parameter of a respective rule of the plurality of rules, if the expression of that respective rule is met by the personality characteristics data;
personalize a game for the user based on the parameters in the generated player profile; and
present the personalized game to the user via a display interface of a computing device.

9. The system of claim 8, the at least one processor further configured to:
present the user with an inquiry via the display interface, the inquiry requesting access to social media data associated with the user on at least one social media platform; and
receive an input from the computing device, the input comprising approval to access the user's social media data,
wherein the personality characteristics data is generated by a sentiment analyzer, the sentiment analyzer accessing the at least one social media platform based on the received input approving access to the user's social media data.

10. The system of claim 8, wherein the personality characteristics data comprises scores for each of a plurality of personality traits of the user.

11. The system of claim 10, wherein the at least one expression includes a comparison of a first of the scores to a pre-determined threshold using an operator.

12. The system of claim 8, wherein personalizing the game comprises personalizing at least one of an environment and gameplay of the game based on the parameters in the generated player profile.

13. The system of claim 8, wherein generating the player profile comprises receiving a default player profile and modifying the default player profile based on the comparison of the personality characteristics data to the plurality of rules.

14. The system of claim 8, wherein the at least one parameter of each of the plurality of rules comprises a plurality of parameters including a category parameter, an attribute parameter associated with the category parameter, and at least one other parameter associated with the attribute parameter that indicates a change to the attribute parameter if the expression for the respective rule is met.

15. A computer readable storage medium comprising instructions that, when executed by at least one processor comprising hardware, configures the at least one hardware processor to:
receive personality characteristics data associated with a user;
compare the personality characteristics data to a plurality of rules, each rule comprising an expression and at least one parameter that is associated with the expression;
generate a player profile for the user based on the comparison of the personality characteristics data to the plurality of rules, a value of at least one parameter in the player profile being determined based on a value of the at least one parameter of a respective rule of the plurality of rules, if the expression of that respective rule is met by the personality characteristics data;
personalize a game for the user based on the parameters in the generated player profile; and
present the personalized game to the user via a display interface of a computing device.

16. The computer readable storage medium of claim 15, the instructions further configuring the at least one processor to:
present the user with an inquiry via the display interface, the inquiry requesting access to social media data associated with the user on at least one social media platform; and
receive an input from the computing device, the input comprising approval to access the user's social media data,
wherein the personality characteristics data is generated by a sentiment analyzer, the sentiment analyzer accessing the at least one social media platform based on the received input approving access to the user's social media data.

17. The computer readable storage medium of claim 15, wherein the personality characteristics data comprises scores for each of a plurality of personality traits of the user, and wherein the at least one expression includes a comparison of one of scores to a pre-determined threshold using an operator.

18. The computer readable storage medium of claim 15, wherein personalizing the game comprises personalizing at least one of an environment and gameplay of the game based on the parameters in the generated player profile.

19. The computer readable storage medium of claim 15, wherein generating the player profile comprises receiving a default player profile and modifying the default player profile based on the comparison of the personality characteristics data to the plurality of rules.

20. The computer readable storage medium of claim 15, wherein the at least one parameter of each of the plurality of rules comprises a plurality of parameters including a category parameter, an attribute parameter associated with the category parameter, and at least one other parameter associated with the attribute parameter that indicates a change to the attribute parameter if the expression for the respective rule is met.
